(19) United States
(12) Patent Application Publication
(10) Pub. No.: US 2025/0167357 A1
(43) Pub. Date: May 22, 2025

(54) BATTERY PACK COVER

(71) Applicant: GM GLOBAL TECHNOLOGY OPERATIONS LLC, Detroit, MI (US)

(72) Inventors: Venkateshwar R. Aitharaju, Troy, MI (US); Bhavesh Shah, Troy, MI (US); Xiaosong Huang, Novi, MI (US); Amogh Deo, Rochester, MI (US)

(21) Appl. No.: 18/516,377

(22) Filed: Nov. 21, 2023

(51) Int. Cl. H01M 50/162; B60L 50/64; H01M 50/15; H01M 50/24

(52) U.S. Cl. CPC H01M 50/162; B60L 50/64; H01M 50/15; H01M 50/24; H01M 2220/20

(57) ABSTRACT

A battery enclosure for a battery system. The system includes: a base configured to support battery cells; and a cover configured to be sealed to the base to enclose the battery cells between the base and the cover, the cover including a non-metallic composite layer and a metallic layer extending across an outer surface of the non-metallic composite layer. The metallic layer is configured to at least partially separate from the non-metallic composite layer in response to a thermal event within the battery enclosure to define an air gap between the metallic layer and the non-metallic composite layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a battery pack cover, and more particularly to a battery pack cover of an enclosure configured to house battery modules and battery cells.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving.

The battery modules and/or battery packs are arranged in enclosures that include a base and a cover. The base and the cover are typically made of metal such as steel or aluminum. In addition to providing structural support functions, the enclosures may also need to perform other functions such as thermal insulation, fire resistance, and/or electromagnetic shielding. When the structural components are made using aluminum or steel, the structural components may be relatively heavy.

### SUMMARY

The present disclosure includes, in various features, a battery enclosure for a battery system. The system includes: a base configured to support battery cells; and a cover configured to be sealed to the base to enclose the battery cells between the base and the cover, the cover including a non-metallic composite layer and a metallic layer extending across an outer surface of the non-metallic composite layer. The metallic layer is configured to at least partially separate from the non-metallic composite layer in response to a thermal event within the battery enclosure to define an air gap between the metallic layer and the non-metallic composite layer.

In further features, the metallic layer is bonded to the non-metallic composite layer with an adhesive, the adhesive configured to release at least a portion of the metallic layer from cooperation with the non-metallic composite layer in response to the thermal event.

In further features, an insulation layer is between the non-metallic composite layer and the metallic layer.

In further features, the non-metallic composite layer includes carbon fibers and the insulation layer includes a glass fiber veil.

In further features, the non-metallic composite layer includes a fire-retardant material.

In further features, the non-metallic composite layer includes a phenolic resin.

In further features, the non-metallic composite layer includes a fire-retardant material combined with at least one of an epoxy composite and a polyester composite.

In further features, the cover further includes a baffle configured to extend into, and abut, the base when the cover is sealed to the base, the baffle including reinforcing fiber tape.

In further features, a seal is between the base and the cover, the baffle is opposite to the seal and inboard of the seal.

In further features, an inside of the cover defines a plurality of receptacles configured to receive a potting material between the battery cells.

The present disclosure further provides for, in various features, a battery enclosure for a battery system. The system includes: a base; a plurality of battery cells spaced apart along the base; a cover over the plurality of battery cells, the cover including a non-metallic composite layer and a metallic layer extending across an outer surface of the non-metallic composite layer, and an inside of the non-metallic composite layer defining a plurality of receptacles; and a potting material between the plurality of battery cells and extending into the plurality of receptacles of the non-metallic composite layer.

In further features, the metallic layer is bonded to the non-metallic composite layer with an adhesive, the adhesive configured to release at least a portion of the metallic layer from cooperation with the non-metallic composite layer in response to a thermal event to define an air gap between the metallic layer and the non-metallic composite layer.

In further features, the present disclosure includes: a seal connecting the cover to the base; and a baffle of the cover between the seal and the plurality of battery cells.

In further features, the baffle includes reinforcing fiber tape.

In various features, the present disclosure also includes a battery enclosure for a battery system. The system includes: a base including a base flange; a plurality of battery cells spaced apart along the base; a potting material between the plurality of battery cells; and a cover. The cover includes: a cover flange, the cover sealed to the base by a seal between the cover flange and the base flange; a plurality of receptacles defined at an inside of the cover, the potting material extending into the plurality of receptacles; a baffle extending into the base beyond the base flange, the baffle between the seal and the plurality of battery cells; a non-metallic composite layer including a fire-retardant material; and a metallic layer secured over an outside of the non-metallic composite layer with an adhesive, the adhesive configured to release at least a portion of the metallic layer in response to a thermal event within the battery enclosure to define an air gap between the metallic layer and the non-metallic composite layer.

In further features, the baffle extends at least 3.0 mm into the base beyond the base flange.

In further features, the baffle includes reinforcing fiber tape, and an outer surface of the baffle faces the seal.

In further features, an outer surface of the baffle contacts the base.

In further features, a distal end of the baffle is one of rounded and flat.

In further features, the plurality of receptacles are one of semi-circular and rounded in cross-section.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an exemplary vehicle including a battery pack with an enclosure in accordance with the present disclosure;

FIG. 2 is a side cross-sectional view of the battery pack including a plurality of battery modules arranged in the enclosure including a cover in accordance with the present disclosure;

FIG. 3 is a side-cross-sectional view of an exemplary battery cell including cathode electrodes, anode electrodes, and separators;

FIG. 4 is a side cross-sectional view of the battery pack including another cover in accordance with the present disclosure;

FIG. 5A is a side view of the cover illustrating a metallic layer of the cover bonded to a non-metallic composite layer of the cover with an adhesive;

FIG. 5B illustrates separation of the metallic layer from the non-metallic composite layer in response to a thermal event to define a gap between the metallic layer and the non-metallic composite layer;

FIG. 5C illustrates an insulation layer between the metallic layer and the non-metallic composite layer; and

FIG. 6 illustrates a fiber tape at a baffle of the non-metallic composite layer.

In the drawings, reference numbers may be reused to identify similar and/or identical elements.

### DETAILED DESCRIPTION

The present disclosure relates to enclosures for battery packs or battery modules. The enclosures include a cover and a base, which is generally a tray that holds the battery packs/modules. The enclosures provide structural rigidity, improve thermal runaway propagation (TRP) protection, and/or provide electromagnetic interference (EMI) shielding. In some examples, the cover includes a relatively light-weight, non-metallic composite layer with fire-retardant material. The non-metallic composite layer is covered with a metallic layer to provide EMI shielding. The metallic layer is configured to separate from the non-metallic composite layer during a thermal event to define an air gap therebetween, thereby reducing heat transfer from the composite layer to the metallic layer, which may keep the metallic layer at a lower temperature relative to the composite layer during at least early stages of a thermal event. In applications where the non-metallic composite layer includes carbon fibers, a glass veil or other insulation layer may be included between the non-metallic composite layer and the metallic layer.

In some examples, the cover includes a baffle, which extends into the base when the cover is sealed to the base. The baffle may extend into the base beyond a base flange of the base, such as 3 mm to 20 mm below the base flange. The cover is sealed to the base with a sealant. The sealant is shielded by the baffle to protect the sealant from a thermal event originating within the enclosure. The baffle is between the sealant and battery cells within the enclosure.

In some examples, the baffle may include reinforcing fibers to enhance thermal and structural performance of the enclosure. The fibers may be continuous fibers, discontinuous fibers, or mixtures thereof including materials such as chopped unidirectional tape, nonwoven mat, and/or directed long fiber melts. Chopped unidirectional tape includes reinforcing fibers attached to, or embedded in, a substrate or backing layer and thermoplastic resin. In some examples, the reinforcing fibers are pre-impregnated with a thermoplastic polymer matrix of the non-metallic composite cover selected from polyether ether ketone (PEEK), polyether ketone ketone (PEKK), polyphenylene sulfide (PPS), polyether imide (PEI), low melt PEEK (LMPEEK or PAEK (e.g., TC1225 (Toray) and AE250 (Victrex)), and combinations thereof.

In some applications, the cover may include internal receptacles configured to receive potting material added between battery modules. The receptacles may be rectangular or spherical in cross-section, for example. The potting material expands within the receptacles and adheres to an inner surface of the receptacles. Cooperation between the potting material and the cover at the receptacles enhances structural rigidity of the enclosure.

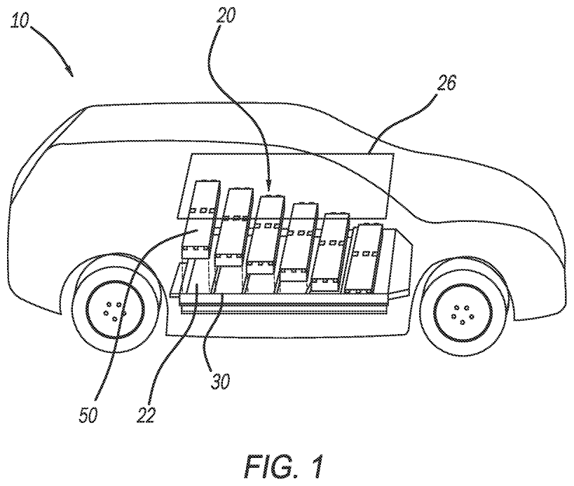

FIG. 1 illustrates an exemplary vehicle 10 including a battery pack 20. The battery pack 20 includes a base 22, or tray, configured to be mounted to the vehicle 10. A cover 26 in accordance with the present disclosure is configured to be mounted to the base 22. The base 22 and the cover 26 together provide an enclosure 30 for any suitable battery modules 50.

Although the cover 26 is illustrated as a cover for a vehicle battery pack, the teachings of present disclosure apply to non-vehicular applications as well. For example, the cover 26 may be included with a non-vehicular battery pack. The cover 26 may be included with an enclosure configured to house any suitable battery cells, such as prismatic battery cells, cylindrical battery cells, etc. The cover 26 may be configured to cover all of the battery modules 50, as illustrated in FIG. 1. The teachings of the present disclosure also apply to covers of the individual battery modules 50. Thus, covers of each one of the battery modules 50 may include some or all of the features and properties of the cover 26 described herein.

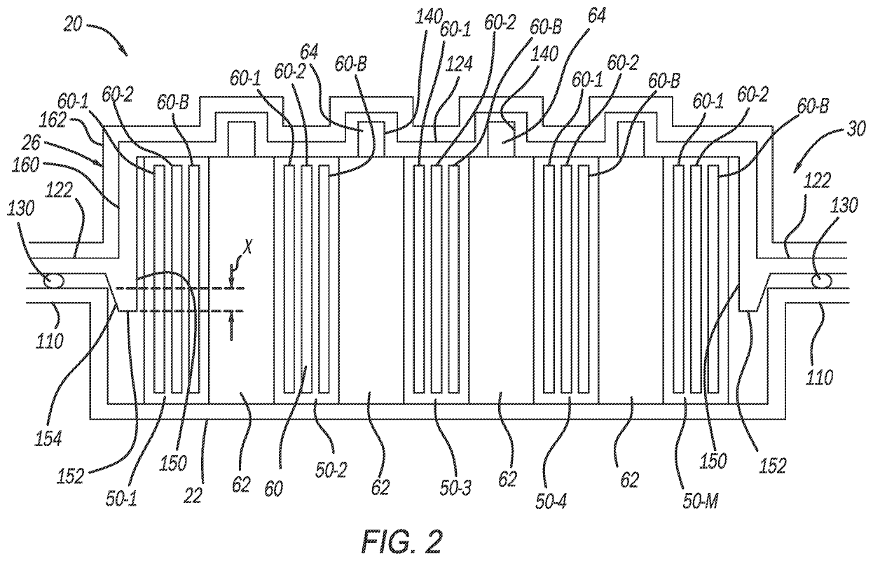

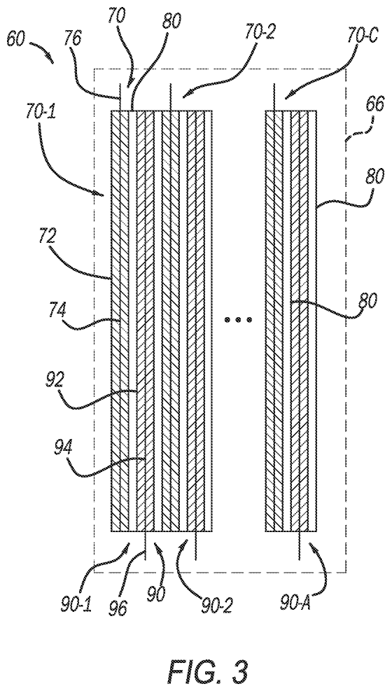

FIG. 2 is a cross-sectional view of the battery pack 20 including a plurality of battery modules 50. Any suitable number of battery modules may be included. The example of FIG. 2 includes battery modules 50-1, 50-2, 50-3, 50-4, and 50-M, where M is any suitable integer greater than 1. FIG. 3 illustrates an exemplary battery cell 60. Each battery module 50 includes any suitable number of battery cells 60. In the example of FIG. 2, each battery module 50 includes battery cells 60-1, 60-2, and 60-B, where B is an integer greater than 1. The battery cells 60 may be prismatic battery cells, cylindrical battery cells, or any other suitable type of battery cells. The battery modules 50 are spaced apart along the base 22. Potting material 62 fills spaces between the battery modules 50, as described further herein.

In the example of FIG. 3, each battery cell 60 includes cathode electrodes 70, such as cathode electrodes 70-1, 70-2, . . . , and 70-C, where C is an integer greater than one. The cathode electrodes 70 include a cathode active material layer 72 arranged on one or both sides of cathode current collectors 74. The battery cell 60 includes anode electrodes 90, such as anode electrodes 90-1, 90-2, . . . , and 90-A, where A is an integer greater than one. The anode electrodes 90 include an anode active material layer 92 arranged on one or both sides of anode current collectors 94. The cathode electrodes 70, the anode electrodes 90, and the separators 80 are arranged in a predetermined order in an enclosure 66 that includes a thermoplastic composite laminated structure. For example, the separators 80 are arranged between the cathode electrodes 70 and the anode electrodes 90. External tabs 76 and 96 can be arranged on the same side, opposite sides, and/or different sides of the current collectors 74, 94.

With renewed reference to FIG. 2, the base 22 includes a base flange 110 extending about an outer perimeter of the base 22. The cover 26 includes a cover flange 122 extending about an outer perimeter of the cover 26. The cover flange 122 is opposite to the base flange 110 when the cover 26 is on the base 22. Between the base flange 110 and the cover flange 122 is a seal 130, which seals the cover 26 to the base 22 and seals the enclosure 30 closed.

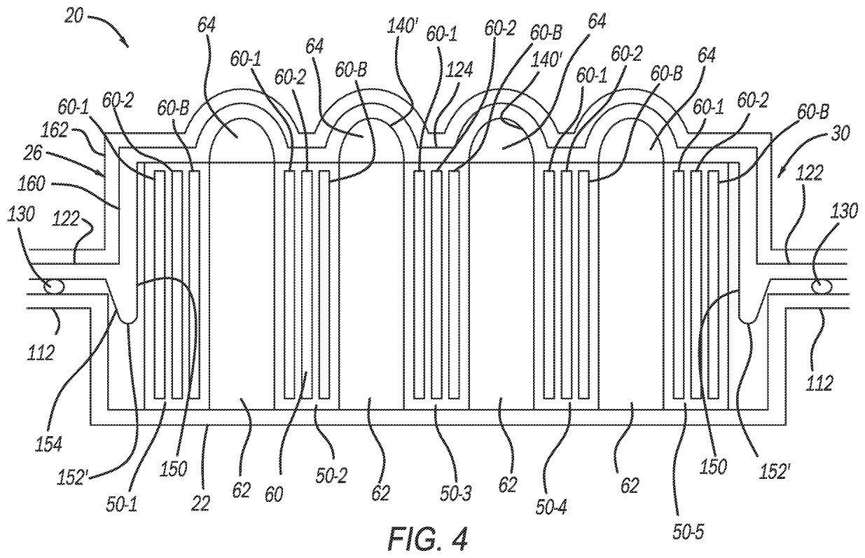

An inner surface of the cover 26 defines a plurality of receptacles 140. The potting material 62 includes an upper portion 64, which extends into the receptacles 140 to interlock with the cover 26 and increase structural rigidity of the enclosure 30. The receptacles 140 may have any suitable cross-sectional shape. For example, the receptacles 140 may have a rectangular shape as illustrated in FIG. 2. Alternatively, the cover 26 may include receptacles 140′, which as illustrated in FIG. 4 have a semi-circular or spherical shape. The rectangular shaped receptacles 140 may have a depth of about 3 mm-10 mm, and a width of about 3 mm-25 mm. The semi-circular shaped receptacles 140′ may have a depth of about 3 mm-10 mm, and a width of about 3 mm-30 mm. The potting material 62 may be any suitable material, such as thermosetting plastics, foam, silicone rubber gel, epoxy resin, etc. The potting material 62 is filled into gaps between the battery modules 50. With the cover 26 sealed to the base 22, the potting material 62 expands into the receptacles 140, 140′ and hardens. The upper portion 64 of the potting material 62 within the receptacles 140, 140′ adheres to the portion of the cover 26 defining the receptacles 140, 140′ to enhance structural rigidity of the enclosure 30.

The cover 26 further includes a baffle 150, which extends around an inside of the cover 26. The baffle 150 includes a distal end 152 and an outer surface 154. When the cover 26 is sealed to the base 22, baffle 150 extends into the base 22 and is surrounded by the base flange 110. The outer surface 154 may contact the base 22 in some applications, or be spaced apart therefrom such that the baffle 150 is closely adjacent to the base flange 110. The baffle 150 may be sized, shaped, and otherwise configured such that the baffle 150 extends any suitable distance X into the base 22 beyond the base flange 110. For example, the distance X may be about 3 mm-20 mm. The distal end 152 may have any suitable shape. For example, the distal end 152 may be planar as illustrated in FIG. 2. FIG. 4 illustrates the distal end 152′ with a rounded shape. The rounded distal end 152′ may have any suitable radius, such as 3 mm to 20 mm.

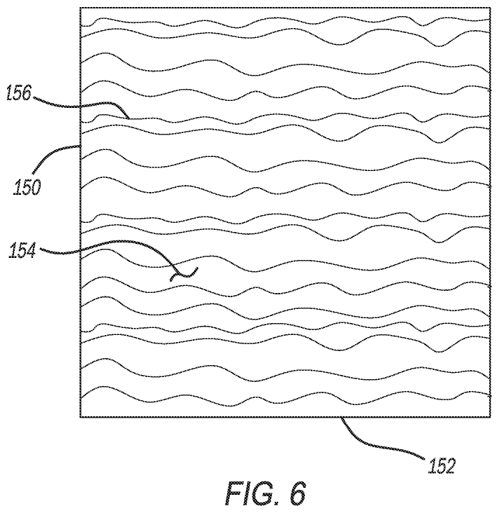

The baffle 150 is between the seal 130 and the battery modules 50. The baffle 150 acts as a barrier protecting the seal 130 from heat that may be generated by a thermal event within the enclosure 30. To reinforce the baffle 150, the baffle 150 may include a reinforcing fibers 156, as illustrated in FIG. 6. The fibers 156 may be oriented such that they extend along a length of the baffle 150. The fibers 156 may be included in a fiber tape at, or proximate to, the outer surface 154 of the baffle 150. The fibers 156 may be included throughout the baffle 150 to enhance both thermal and structural performance. The reinforcing fibers 156 may be co-molded with the cover 26. During molding, at and near the baffle 150 a relatively higher temperature may be maintained, such as 20° C.-50° C., to increase the curing rate of the relatively thicker baffle 150.

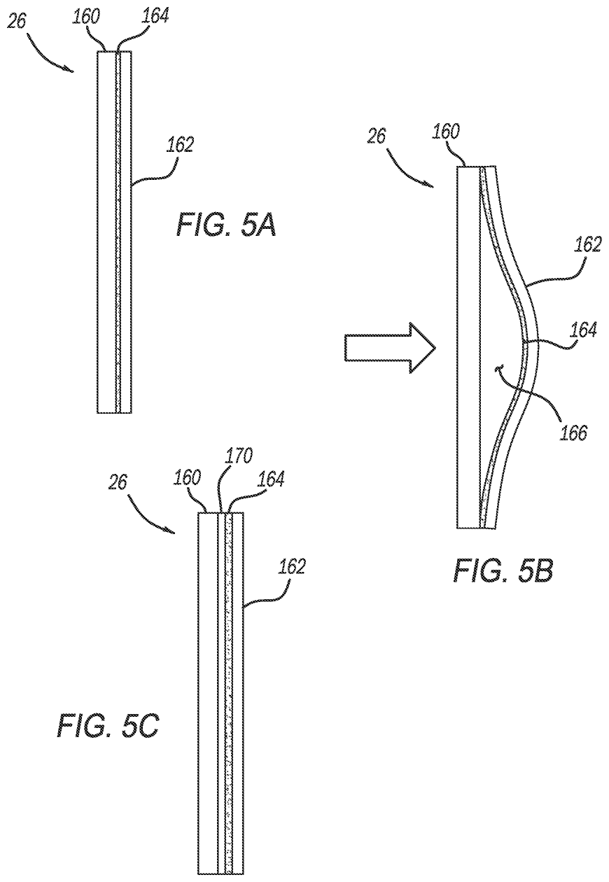

The cover 26 generally includes a non-metallic composite layer 160 and a metallic layer 162 bonded to an outside of the non-metallic composite layer 160. The metallic layer 162 may be bonded to the non-metallic composite layer 160 in any suitable manner, such as with an adhesive layer 164 as illustrated in FIG. 5A. The non-metallic composite layer 160 includes any suitable fire-retardant material. For example, the non-metallic composite layer 160 may include a fire-retardant phenolic resin. As another example, the non-metallic composite layer 160 may be made of a material that is not inherently fire-retardant, such as an epoxy composite and/or a polyester composite, but which is combined with any suitable fire-retardant material. The non-metallic composite layer 160 may be formed using any suitable process, such as compression molding or resin transfer molding (RTM). To facilitate curing of the non-metallic composite layer at the baffle 150, the mold tool may be kept at 20° C.-50° C. above the tool temperature.

The metallic layer 162 may be made of any suitable metallic material, such as aluminum or steel. The metallic layer 162 strengthens the cover 26 and acts as a Faraday shield to contain electrical signals within the enclosure 30 and prevent the electrical signals from interfering with other electrical components of the vehicle 10. The metallic layer 162 may have any suitable thickness, such as about 0.1 mm to about 1.0 mm. The metallic layer 162 is bound to the non-metallic composite layer 160 by way of the adhesive layer 164 by applying pressure of 50-500 psi, for example, at a temperature below 100° C., for example.

With reference to FIG. 5B, the cover 26 is configured so that the metallic layer 162 separates from the non-metallic composite layer 160 during a thermal event within the enclosure 30 to define an air gap 166 therebetween. Specifically, the adhesive layer 164 is configured to release the metallic layer 162 from cooperation with the non-metallic composite layer 160 in response to a thermal event. For example, the adhesive layer 164 may be configured to melt at a predetermined temperature corresponding to a temperature associated with a thermal event within the enclosure 30. The adhesive layer 164 may also be configured to release the metallic layer 162 from cooperation with the non-metallic composite layer 160 in response to stresses exerted upon the adhesive layer 164 by the non-metallic composite layer 160 and/or the metallic layer 162, which have different coefficients of thermal expansion, during a thermal event. Once the adhesive layer 164 fails or otherwise releases the metallic layer 162, the metallic layer 162 expands further due to it having a relatively high coefficient of thermal expansion (CLTE), and the metallic layer 162 bulges away from the non-metallic composite layer 160, which has a relatively lower CLTE. The air gap 166 forms a thermal barrier, effectively maintaining the metallic layer 162 at a lower temperature than the non-metallic composite layer 160 during a thermal event, such as lower than 370° C., for example.

FIG. 5C illustrates an optional insulation layer 170 between the non-metallic composite layer 160 and the metallic layer 162. The insulation layer 170 may include a glass fiber veil, for example. The insulation layer 170 may be included when the non-metallic composite layer 160 includes carbon fibers to protect the metallic layer 162, such as from galvanic corrosion, for example.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery enclosure for a battery system, comprising:
a base configured to support battery cells; and
a cover configured to be sealed to the base to enclose the battery cells between the base and the cover, the cover including a non-metallic composite layer and a metallic layer extending across an outer surface of the non-metallic composite layer;
wherein the metallic layer is configured to at least partially separate from the non-metallic composite layer in response to a thermal event within the battery enclosure to define an air gap between the metallic layer and the non-metallic composite layer.

2. The battery enclosure of claim 1, wherein the metallic layer is bonded to the non-metallic composite layer with an adhesive, the adhesive configured to release at least a portion of the metallic layer from cooperation with the non-metallic composite layer in response to the thermal event.

3. The battery enclosure of claim 1, further comprising an insulation layer between the non-metallic composite layer and the metallic layer.

4. The battery enclosure of claim 3, wherein the non-metallic composite layer includes carbon fibers and the insulation layer includes a glass fiber veil.

5. The battery enclosure of claim 1, wherein the non-metallic composite layer includes a fire-retardant material.

6. The battery enclosure of claim 1, wherein the non-metallic composite layer includes a phenolic resin.

7. The battery enclosure of claim 1, wherein the non-metallic composite layer includes a fire-retardant material combined with at least one of an epoxy composite and a polyester composite.

8. The battery enclosure of claim 1, wherein the cover further includes a baffle configured to extend into, and abut, the base when the cover is sealed to the base, the baffle including reinforcing fiber tape.

9. The battery enclosure of claim 8, further comprising a seal between the base and the cover, the baffle is opposite to the seal and inboard of the seal.

10. The battery enclosure of claim 1, wherein an inside of the cover defines a plurality of receptacles configured to receive a potting material between the battery cells.

11. A battery enclosure for a battery system, comprising:
a base;
a plurality of battery cells spaced apart along the base;
a cover over the plurality of battery cells, the cover including a non-metallic composite layer and a metallic layer extending across an outer surface of the non-metallic composite layer, and an inside of the non-metallic composite layer defining a plurality of receptacles; and
a potting material between the plurality of battery cells and extending into the plurality of receptacles of the non-metallic composite layer.

12. The battery enclosure of claim 11, wherein the metallic layer is bonded to the non-metallic composite layer with an adhesive, the adhesive configured to release at least a portion of the metallic layer from cooperation with the non-metallic composite layer in response to a thermal event to define an air gap between the metallic layer and the non-metallic composite layer.

13. The battery enclosure of claim 11, further comprising:
a seal connecting the cover to the base; and
a baffle of the cover between the seal and the plurality of battery cells.

14. The battery enclosure of claim 13, wherein the baffle includes reinforcing fiber tape.

15. A battery enclosure for a battery system, comprising:
a base including a base flange;
a plurality of battery cells spaced apart along the base;
a potting material between the plurality of battery cells; and
a cover including:
a cover flange, the cover sealed to the base by a seal between the cover flange and the base flange;
a plurality of receptacles defined at an inside of the cover, the potting material extending into the plurality of receptacles;
a baffle extending into the base beyond the base flange, the baffle between the seal and the plurality of battery cells;
a non-metallic composite layer including a fire-retardant material; and
a metallic layer secured over an outside of the non-metallic composite layer with an adhesive, the adhesive configured to release at least a portion of the metallic layer in response to a thermal event within the battery enclosure to define an air gap between the metallic layer and the non-metallic composite layer.

16. The battery enclosure of claim 15, wherein the baffle extends at least 3.0 mm into the base beyond the base flange.

17. The battery enclosure of claim 15, wherein the baffle includes reinforcing fiber tape, and an outer surface of the baffle faces the seal.

18. The battery enclosure of claim 15, wherein an outer surface of the baffle contacts the base.

19. The battery enclosure of claim 15, wherein a distal end of the baffle is one of rounded and flat.

20. The battery enclosure of claim 15, wherein the plurality of receptacles are one of semi-circular and rounded in cross-section.
